(19) United States
(12) Patent Application Publication
(10) Pub. No.: US 2016/0159665 A1
(43) Pub. Date: Jun. 9, 2016

(54) SYSTEM FOR TREATING WASTE WATER CONTAINING AT LEAST ONE COSMETIC PRODUCT, AND RELATED ARRANGEMENT AND METHOD

(71) Applicant: L'OREAL, Paris (FR)

(72) Inventors: Alexandre Nicolas, Tokyo (JP); Christophe Hadjur, Singapore (SG)

(21) Appl. No.: 14/781,100

(22) PCT Filed: Mar. 28, 2014
(86) PCT No.: PCT/EP2014/056352

§ 371 Date: Jan. 19, 2016

(30) Foreign Application Priority Data
Mar. 29, 2013 (FR) 13 52921

(51) Int. Cl. C02F 1/24; A45D 19/10

(52) U.S. Cl. CPC C02F 1/24; A45D 19/10; C02F 2101/301

(57) ABSTRACT

This system (18) comprises a holding and separating tank (36), an inlet (38) for moving untreated waste water into the holding tank (36), and a bubble generator (32), able to introduce a quantity of bubbles into the waste water of the holding tank (36), in order to form, in a lower region (50) of the holding tank (36), a treated water and, in an upper region (52) of the holding tank (36), a supernatant.

The system (18) comprises a lower outlet (40) for recovering a treated water from the holding tank (36) and an upper outlet (42) for discharging a foamy supernatant from the holding tank (36).

The system (18) is devoid of means for injecting a compound for flocculating and/or coagulating the waste water, at least upstream from the holding tank (36).

This invention relates to a system for treating waste water containing at least one cosmetic product, the system being able to be placed in an application space for applying a cosmetic product on a user.

Such a system is intended in particular to be connected to a receptacle for collecting waste water present in the application space of the cosmetic product, in order to treat directly in this space, the waste water that is generated during a cosmetic treatment performed on a user.

The application space for the cosmetic product is for example a hairdresser, a beauty salon, a spa or thalassotherapy facility. Alternatively, the application space is located in a dwelling, for example in the home of the user.

“Cosmetic product” means in particular, in the sense of this invention, a product such as defined in EC Regulation no. 1223/2009 of the European Parliament and of the Council of Nov. 30, 2009 relating to cosmetic products.

The cosmetic product is for example a liquid, a gel, a cream, an emulsion applied to a body surface of a user, in particular on a keratin surface such as the skin and hair.

The cosmetic product is advantageously rinsed with rinse water, to be partially removed from the body surface. In particular, the cosmetic product is a shampoo applied to the hair of a user, the shampoo then being rinsed with rinse water. Alternatively, the product is a soap applied to the skin of the user and rinsed with rinse water.

Rinsing a cosmetic product such as shampoo or soap generates a non-negligible quantity of waste water containing the cosmetic product. This waste water is generally collected in an open receptacle for collection, such as a sink or washbasin. The quantity of waste water is for example from 7 to 25 liters in the case of a shampoo rinse.

In most industrialized countries, the waste water collected as such is sent to a water treatment plant through a sewage system, to be purified before being released into the environment or reused.

However, in some areas, wastewater is only partially collected, and even not collected at all. In certain cases, the industrial capabilities for water treatment may be very limited, either temporarily, for example in the case of a storm, or permanently, due to lack of treatment capacity.

Waste water typically contains surfactants, and in certain cases, preservatives, impurities, silicones, etc. Most of these compounds are biodegradable, but may still have an impact on the environment.

To reduce the environmental impact of cosmetic products, it is known to promote their biodegradability, or provide formulas that can be rinsed with a lesser quantity of rinse water.

However, these solutions are expensive and are not suitable in areas that are partially or totally deprived of industrial water treatment facilities.

WO 2011/026197 describes a water purification system for a vessel, wherein a flocculant and coagulant is injected into the waste water. Such a system therefore has an environmental impact. In addition, the system for managing the flocculant and the coagulant is complex, cumbersome and difficult to implement. WO 2006/131743, WO 2011/137490, and WO 2012/061905 describe water treatment systems.

An object of the invention is therefore to provide a system for treating waste water that contains at least one cosmetic product, the system able be used simply and inexpensively in the case where an industrial water treatment capacity is not available, or is partially available.

For this purpose, the subject-matter of the invention is a system of the aforementioned type, comprising:

a tank for holding and separating the waste water;

an inlet for moving untreated waste water into the holding tank;

a bubble generator, able to introduce a quantity of bubbles into the waste water of the holding tank, in order to form, in a lower region of the holding tank, a treated water and, in an upper region of the holding tank, a supernatant;

a lower outlet for recovering treated water from the holding tank;

an upper outlet for discharging a foamy supernatant from the holding tank;

the system being devoid of means for injecting a compound for flocculating and/or coagulating the waste water, at least upstream from the holding tank.

The system according to the invention can include one or more of the following features, taken alone or in any technically possible combination:

the bubble generator comprises an upstream pipe for sampling a relatively bubble-free water in the holding tank, and a downstream pipe for injecting water relatively rich in bubbles into the holding tank.

the bubble generator comprises an air inlet and a water pump, capable of mixing air taken through the air inlet with the relatively bubble-free water coming from the upstream pipe to form the water relatively rich in bubbles to be conveyed by the downstream pipe;

a trap for collecting the foamy supernatant, connected to the upper discharge outlet, the collection trap being connected to a source of vacuum, able to generate a pressure in the collection trap lower than the pressure prevailing in the holding tank;

the bubble generator comprises the source for the vacuum;

the vacuum source is formed by the water pump, with the air inlet being connected to the collection trap;

an intermediate protection receptacle, interposed between the collection trap and the vacuum source;

the inside volume of the holding tank is less than 100 liters;

the bubble generator is able to generate bubble of average size less than 0.5 mm;

The invention also relates to an arrangement for applying cosmetic product on a user, including:

a source of rinse water for the cosmetic product

an open receptacle for collecting waste water formed from the rinse water and containing the cosmetic product;

a system such as defined hereinabove, with the inlet connected to the open receptacle.

The arrangement according to the invention can include one or more of the following features, taken alone or in any technically possible combination:

a bottom of the open receptacle is arranged at a height greater than a bottom of the holding tank in order to allow for the flow via gravity of the waste water collected in the open receptacle to the holding tank;

a seat, able to receive a user, with the seat being placed in the vicinity of the open receptacle and/or of the waste water treatment system.

The invention also has for object a method for treating waste water containing at least one cosmetic product, comprising the following steps:

supplying, in an application space of the cosmetic product on a user, a system such as defined hereinabove;

conveying waste water containing at least one cosmetic product in the holding tank though the inlet;

introducing a quantity of air bubbles into the waste water, through the intermediary of the bubble generator;

forming of treated water in an lower region of the holding tank and of a supernatant in an upper region of the holding tank;

recovering treated water via the lower sampling outlet;

discharging the supernatant by the upper discharge outlet;

the method being devoid of a step of injecting a compound for flocculating and/or coagulating the waste water, at least upstream of its passage into the holding tank.

The method according to the invention can include one or more of the following features, taken alone or in any technically possible combination:

a step of collecting the supernatant in a collection trap connected to the upper discharge outlet, with the step of collecting comprising the application of pressure in the collection trap that is lower than the pressure prevailing in the holding tank by a vacuum source;

the step of introducing a quantity of bubbles into the waste water comprises the sampling of relatively bubble-free water in the holding tank, and the introducing of relatively bubble-free water into a water pump, with an air inlet of the water pump being connected to the collection trap, with air sampled in the collection trap in order to reduce the pressure in the collection trap, with the air sampled in the collection trap being injected into the relatively bubble-free water through the air inlet in order to form relatively bubble-rich water.

The invention will be easier to understand in view of the following description, provided solely as an example, and with reference to the appended drawings, wherein:

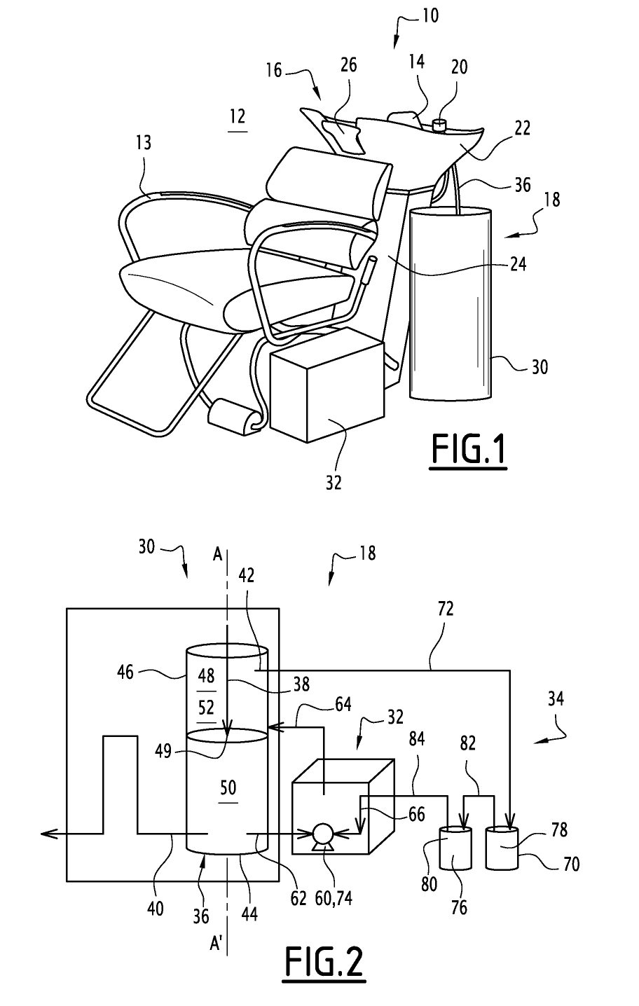

FIG. 1 is a partial diagrammatical perspective view of a first arrangement of the application of a cosmetic product, equipped with a system for treating waste water according to the invention;

FIG. 2 is a block diagram illustrating the various components of the treatment system of FIG. 1;

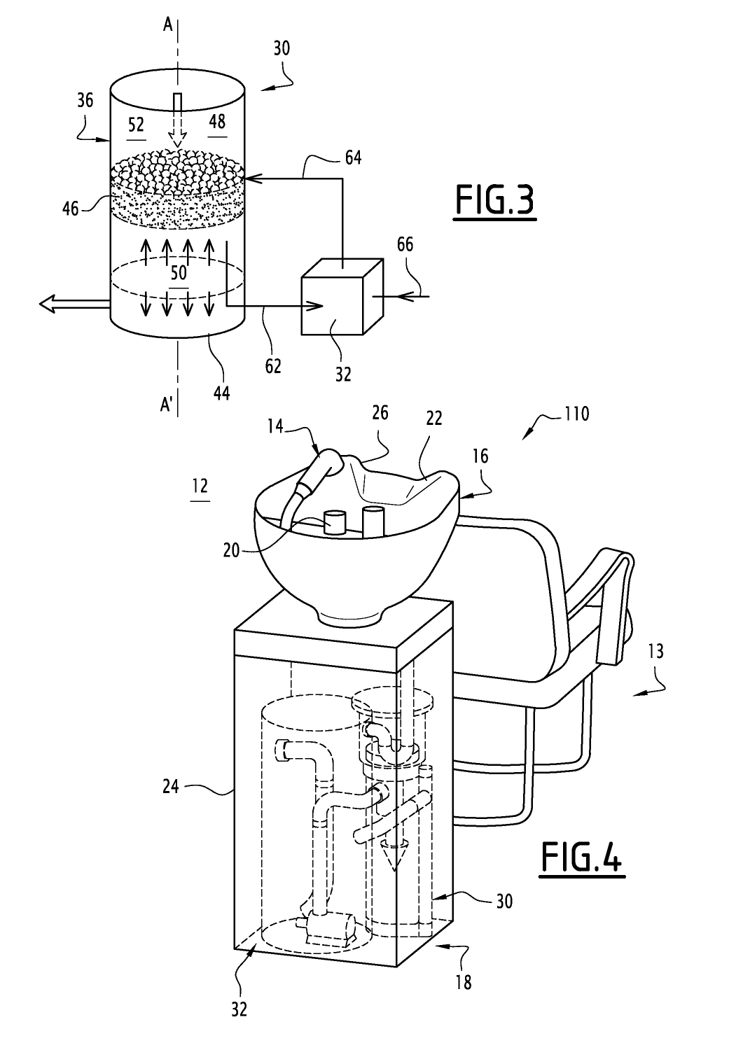

FIG. 3 is an enlarged diagrammatical view of a holding and separating tank of the system of FIG. 2, wherein the principle of separating waste water is illustrated;

FIG. 4 is a rear perspective view of a second arrangement of application of a cosmetic product according to the invention.

Below, the terms “upstream” and “downstream” generally refer to the normal direction of circulation of a fluid.

A first arrangement 10 according to the invention, intended for applying a cosmetic product on a user, is illustrated in FIG. 1.

The arrangement 10 is placed in an application space 12 for a cosmetic product. It is configured for the application of a cosmetic product on a body surface of a user, followed by a rinsing at least partially of the cosmetic product by rinse water.

The application space 12 for the cosmetic product is for example a hairdresser, a beauty salon, a spa or thalassotherapy facility. Alternatively, the application space 12 is located in a dwelling, for example in the home of the user.

The cosmetic product is in particular a liquid, a gel, a cream, an emulsion applied to a body surface of a user, in particular on a keratin surface such as the skin and hair.

The cosmetic product is able to be rinsed with rinse water, to be partially removed from the body surface. In particular, the cosmetic product is a shampoo applied to the hair of a user, the shampoo then being rinsed with rinse water.

Alternatively, the cosmetic product is a soap applied to the skin of a user, the soap then being rinsed with rinse water.

In reference to FIG. 1, the arrangement 10 preferably comprises a seat 13 able to receive the user. It comprises a source 14 of rinse water, able to be distributed onto the body surface of a user wearing a cosmetic product, and an open receptacle 16, intended to collect waste water formed by the rinse water containing the cosmetic product.

The arrangement 10 further comprises a system 18 for treating waste water, illustrated in more detail in FIG. 2.

The source 14 of rinse water comprises a member 20 for distributing rinse water, for example a tap and/or a shower.

The open receptacle 16 comprises a collection tank 22 open upwards, and a support 24.

The collection tank 22 is mounted on the support 24 in order to be arranged facing the head of a user when the user is seated on the seat 13. Here, the collection tank 22 delimits a notch 26 for the passing of the neck of the user, placed facing the seatback of the seat 13.

In this example, the treatment system 18 is placed in the vicinity of the receptacle 16 and/or of the seat 13, advantageously in contact with the receptacle 16 and/or the seat 13.

The treatment system 18 comprises a unit 30 for receiving and separating waste water, a generator 32 of bubbles in the waste water, in order to form a treated water and a supernatant, and a unit 34 for collecting the supernatant.

In reference to FIG. 2 and FIG. 3, the unit 30 for receiving and separating comprises a tank 36 for holding and separating waste water, and an inlet 38 for moving waste water into the holding tank 36.

The unit 30 further comprises a lower outlet 40 for recovering treated water and an upper outlet 42 for discharging the supernatant.

The holding tank 36 is arranged in the vicinity and/or in contact with the receptacle 16 for collecting waste water.

The tank 36 comprises a bottom 44 and a side wall 46 delimiting an inner space 48 for receiving waste water.

The bottom 44 and preferably the inner space 48 are located at a height less than that of the bottom of the collection tank 22, in order to allow for the flow via gravity of the waste water contained in the collection tank 22 to the holding tank 36.

In this example, the tank 36 is elongated along an vertical axis A-A′. It advantageously has a circular or polygonal contour in order to adapt to the space available in the vicinity of the receptacle 16.

The inner space 48 has a volume advantageously less than 100 liters, preferably less than 70 liters, in particular between 10 liters and 60 liters.

The inlet for moving water 38 is formed by a pipe connected to the collection tank 32. It opens upstream directly into the collection tank 32.

The inlet for moving water 38 protrudes into the holding and separating tank 36. It opens downstream into the inner space 48, through a downstream opening 49, located advantageously at a height between 30% and 70% of the height of the inner space 48, in particular substantially at mid-height of the inner space 48.

As we will see later, this makes it possible to accommodate a sufficient volume of supernatant in the inner space 48.

According to the invention, the system 18, is devoid of means for injecting a compound for coagulating and/or flocculating, in particular at the inlet for moving water 38, between the open tank 22 for collecting waste water and the inner space 48 of the holding tank 36.

As such, the waste water collected in the open tank 22 is conveyed directly and without coagulating and/or flocculating treatment to the inner space 48 of the holding tank 36 through the inlet for moving water 38.

This substantially reduces the environmental impact of the system 18.

The lower outlet 40 for recovering is tapped on the tank 36, below the downstream opening 49 of the inlet for moving 38. The lower outlet is advantageously arranged through the side wall 46, in the vicinity of the bottom 44 or in the bottom 44. It opens upstream into a lower region 50 of the inner space 48, intended to receive treated water.

The upper outlet 42 for discharging is tapped on the tank 46, above the downstream opening 49 of the inlet for moving 38. It is advantageously arranged in the vicinity of its upper edge, through the side wall 46. It opens upstream into an upper region 52 of the inner space 48, intended to receive a supernatant.

The bubble generator 32 is able to form a large quantity of air bubbles in the waste water, in order to create a significant air-water interface, in order to collect at this interface the surfactants and/or hydrophobic compounds and/or the impurities present in the waste water.

This purifies the waste water, generating a treated water, relatively devoid of surfactants and/or hydrophobic compounds and/or the impurities, and a foamy supernatant, relatively rich in surfactants and/or hydrophobic compounds and/or the impurities.

Preferably, the bubble generator 32 is able to create micro-bubbles, i.e. bubbles that have an average dimension less than 0.5 mm. The size of the bubbles is measured for example by contrast ultrasonography.

To this effect, the bubble generator 32 comprises a water pump 60, an upstream pipe 62 for sampling a relatively bubble-free water in the holding tank 36, and a downstream pipe 64 for injecting water relatively rich in bubbles into the holding tank 36.

The bubble generator 32 further comprises an air inlet 66 connected to the water pump 60.

The water pump 60 is for example of the rotary vane pump type where the fluid flow thanks to the rotation around an axis of vanes in a chamber that is advantageously circular.

The water pump 60 is able to inject a quantity of air bubbles into the relatively bubble-free water coming from the upstream pipe 62, from the air collected through the air inlet 66, in order to form the relatively bubble-rich water pushed back into the downstream pipe 64.

“Relatively bubble-free” means that the volume of air present in the relatively bubble-free water is preferably less than 15% of the volume of water present in the relatively bubble-free water.

“Relatively bubble-rich” means that the volume of air present in the relatively bubble-rich water is preferably less than 15% of the volume of water present in the relatively bubble-rich water.

The upstream pipe 62 opens upstream into the lower region 50 of the inner space 48, in the vicinity of the bottom 44 or in the bottom 44. It opens downstream into an admission inlet of the pump 60.

The downstream pipe 64 opens upstream into a delivery outlet of the pump 60. It opens downstream into the inner space 48, advantageously into the upper region 52, in the vicinity of the downstream opening 49 of the inlet for moving 38. A shower (not shown) can be placed at the downstream end of the downstream pipe 64 in the inner space 48.

The unit for collecting 34 the supernatant comprises a collection trap 70, and a pipe 72 for discharging the supernatant, connecting the upper outlet 42 to the collection trap 70.

The unit for collecting 34 further comprises a source 74 for a vacuum of the collection trap 70 and advantageously, an intermediate receptacle 76 for protecting the source 74.

The collection trap 70 is intended to treat the foamy supernatant in order to reduce its volume and form a liquid residue. It advantageously has an inner space 78 with a volume less than the volume of the inner space 48 of the holding and separating tank 36. This volume is for example between 1 liter and 2 liters.

The inner space 78 of the collection trap 70 is able to be subjected to a pressure less than the pressure that prevails in the inner space 48 of the holding and separating tank 36, by the intermediary of the source 74 for the vacuum.

The difference in pressure between the inner space 78 and the inner space 48 is generated by a flow of aspiration of air that is advantageously greater than 1 NL/min.

The discharging pipe 72 is connected upstream to the upper outlet 42. It opens downstream inti the inner space 78.

In this example, the vacuum source 74 is formed by the pump 60. To this effect, the inner space 78 is connected to the air inlet 66, causing an aspiration of air into the inner space 78 when the pump 60 is operating.

When it is present, the intermediate receptacle 76 is interposed between the air inlet 66 and the inner space 78. It delimits an inner volume 80 for eliminating liquid connected upstream to the inner space 78 by an upstream tapping 82 and downstream at the air inlet 66 by a downstream tapping 84.

As such, a possible liquid sampled in the collection trap 70 is collected in the inner volume 80, which prevents it from being introduced into the air inlet 66 of the pump 60.

The operation of the arrangement 10 and of the treatment system 18 will now be described.

Initially, the cosmetic product applied beforehand on the user is rinsed at least partially using the source 14 of rinse water. It forms, with the rinse water, a waste water collected in the collection tank 22.

The waste water flows, advantageously via gravity, from the collection tank 22 to the holding tank 36 through the upstream inlet 38. The waste water accumulates in the lower region 50 of the inner space 48. No flocculating and/or coagulating product is injected into the waste water collected in the collection tank 22.

When the treatment of the waste water must be carried out, the bubble generator 32 is activated. Relatively bubble-poor water is taken from the lower region 50 of the inner space 48 through the upstream pipe 62.

The relatively bubble-free water is then pumped into the water pump 60 and receives air coming from the air inlet 66. This air is injected in the form of bubbles, advantageously micro-bubbles, as such forming a relatively bubble-rich water.

Relatively bubble-rich water is then reinjected into the inner space 48 through the downstream pipe 64.

A maximum air-water interface is then generated. The surfactants, hydrophobic compounds, and certain impurities are collected spontaneously at the air-water interface, and rise via gravity in the form of a foam to the upper region 52.

As such, a purified water, substantially free of bubbles and relatively poor in surfactants, and/or hydrophobic compounds and/or impurities is formed in the lower region 50.

The purified water can be recovered through the inner outlet 40, advantageously to be reused in the application space 12 for the cosmetic product.

A foamy supernatant is formed in the upper region 52, the supernatant being relatively rich in surfactants, and/or hydrophobic compounds and/or impurities.

The separation carried out in the holding tank 36 does also not require the use of flocculating and/or coagulating compounds.

Under the effect of the aspiration of air of the pump 60 forming the source 74 of the vacuum, a pressure lower than the pressure that prevails in the inner space 48 is generated in the inner space 78 of the collection trap 70.

The foamy supernatant is then aspirated through the upper outlet 42, then through the discharge pipe 72, to be collected in the trap 70.

Under the effect of the low pressure prevailing in the inner space 78 of the trap 70, the foam is reduced and forms a liquid containing the surfactants, and/or hydrophobic compounds and/or other impurities.

No flocculating and/or coagulating compound is used either for treating the supernatant.

According to the invention, simply applying a vacuum on the foamy supernatant makes it possible to effectively treat it by reducing its volume, in order to collect a concentrated liquid of low volume.

This concentrated liquid can then be removed periodically and treated outside the application space 12.

The treatment system 18 according to the invention is therefore particularly effective and compact. It does not require the use of flocculating and/or coagulating compounds, and therefore has a minimum environmental impact, while still offering a highly effective and rapid treatment of waste water.

In the second arrangement 110 according to the invention, the recovering and separating unit 30, as well as the bubble generator 32 are received in the support 24, under the collection tank 22. The arrangement 110 is therefore particularly compact.

The treatment system 18 of the arrangement 110 is moreover similar to the treatment system 18 of the arrangement 10 and operates in the same way.

In the examples shown in FIGS. 1 and 4, a treatment system 18 is associated with each arrangement 10, 110. Alternatively, a treatment system 18 can be common to several arrangements 10, 110.

In an alternative, a filter, in particular a filter made of activated carbon, for example in the form of a cartridge, is interposed on the outlet 40 in order to finalize the treatment. A pump can then be added in order to offset the loss of load.

This filter collects the impurities present in the water, even after it has been treated.

Moreover, a pre-filter can be added on the downstream pipe 64 in order to ensure the longevity of the pump and prevent any degradation.

In another alternative, an injector of a treatment gas, such as ozone, is arranged on the air inlet 66, in order to sanitize the treated water, preventing microbial contamination.

1. System for treating waste water containing at least one cosmetic product, the system being able to be placed in an application space for applying a cosmetic product on a user, the system comprising:
a tank for holding and separating the waste water;
an inlet for moving untreated waste water into the holding tank;
a bubble generator, able to introduce a quantity of bubbles into the waste water of the holding tank, in order to form, in a lower region of the holding tank, a treated water and, in an upper region of the holding tank, a supernatant;
a lower outlet for recovering treated water from the holding tank;
an upper outlet for discharging a foamy supernatant from the holding tank;
the system being devoid of means for injecting a compound for flocculating and/or coagulating the waste water, at least upstream from the holding tank.

2. System according to claim 1, wherein the bubble generator comprises an upstream pipe for sampling a relatively bubble-free water in the holding tank, and a downstream pipe for injecting water relatively rich in bubbles into the holding tank.

3. System according to claim 2, wherein the bubble generator comprises an air inlet and a water pump, capable of mixing air taken through the air inlet with the relatively bubble-free water coming from the upstream pipe to form the water relatively rich in bubbles to be conveyed by the downstream pipe.

4. System according to claim 3, comprising a trap for collecting the foamy supernatant, connected to the upper discharge outlet, the collection trap being connected to a vacuum source, able to generate a pressure in the collection trap lower than the pressure prevailing in the holding tank.

5. System according to claim 4, wherein the bubble generator comprises the vacuum source.

6. System according to claim 5, wherein the vacuum source is formed by the water pump, with the air inlet being connected to the collection trap.

7. System according to claim 4, comprising an intermediate receptacle for protection, interposed between the collection trap and the vacuum source.

8. System according to claim 1, wherein the inner volume of the holding tank is less than 100 liters.

9. System according to claim 1, wherein the bubble generator is able to generate bubble of an average size less than 0.5 mm.

10. Arrangement for applying cosmetic product on a user, including:
a source of rinse water for the cosmetic product
an open receptacle for collecting waste water formed from the rinse water and containing the cosmetic product;
a system according to any one of the previous claims, with the inlet connected to the open receptacle.

11. Arrangement according to claim 10, wherein a bottom of the open receptacle is arranged at a height greater than a bottom of the holding tank in order to allow for the flow via gravity of the waste water collected in the open receptacle to the holding tank.

12. Arrangement according to claim 10, comprising a seat, able to receive a user, with the seat being placed in the vicinity of the open receptacle and/or of the waste water treatment system.

13. Method for treating waste water containing at least one cosmetic product, comprising the following steps:
supplying, in an application space of the cosmetic product on a user, a system according to claim 1;
conveying waste water containing at least one cosmetic product in the holding tank though the inlet;
introducing a quantity of air bubbles into the waste water, through the intermediary of the bubble generator;
forming of treated water in an lower region of the holding tank and of a supernatant in an upper region of the holding tank;
recovering treated water via the lower sampling outlet;
discharging the supernatant by the upper discharge outlet;
the method being devoid of a step of injecting a compound for flocculating and/or coagulating the waste water, at least upstream of its passage into the holding tank.

14. Method according to claim 13, comprising a step of collecting the supernatant in a collection trap connected to the upper discharge outlet, with the step of collecting comprising the application of pressure in the collection trap that is lower than the pressure prevailing in the holding tank by a vacuum source.

15. Method according to claim 14, wherein the step of introducing a quantity of bubbles into the waste water comprises the sampling of relatively bubble-free water in the holding tank, and the introducing of relatively bubble-free water into a water pump, with an air inlet of the water pump being connected to the collection trap, with air sampled in the collection trap in order to reduce the pressure in the collection trap, with the air sampled in the collection trap being injected into the relatively bubble-free water through the air inlet in order to form relatively bubble-rich water.

16. System according to claim 1, comprising a trap for collecting the foamy supernatant, connected to the upper discharge outlet, the collection trap being connected to a vacuum source, able to generate a pressure in the collection trap lower than the pressure prevailing in the holding tank.

17. System according to claim 2, comprising a trap for collecting the foamy supernatant, connected to the upper discharge outlet, the collection trap being connected to a vacuum source, able to generate a pressure in the collection trap lower than the pressure prevailing in the holding tank.

18. System according to claim 16, comprising an intermediate receptacle for protection, interposed between the collection trap-and the vacuum source.

19. System according to claim 5, comprising an intermediate receptacle for protection, interposed between the collection trap-and the vacuum source.

20. System according to claim 6, comprising an intermediate receptacle for protection, interposed between the collection trap-and the vacuum source.
